(19) United States
(12) Patent Application Publication
(10) Pub. No.: US 2016/0026986 A1
(43) Pub. Date: Jan. 28, 2016

(54) SECURE BILLING SYSTEM FOR FUEL AND GAS SALES

(71) Applicants: Stephen Foster, Birchgrove (AU); Kevin Peakman, Burraneer (AU)

(72) Inventors: Stephen Foster, Birchgrove (AU); Kevin Peakman, Burraneer (AU)

(21) Appl. No.: 14/741,732

(22) Filed: Jun. 17, 2015

Related U.S. Application Data
(60) Provisional application No. 62/027,989, filed on Jul. 23, 2014.

(51) Int. Cl. G06Q 20/20

(52) U.S. Cl. CPC G06Q 20/20

(57) ABSTRACT

An improved billing system for the dispensing of fuel and gas products is described. The system is comprised of non-proprietary (off the shelf) components that can be controlled by the fuel and gas seller. This avoids the need to use proprietary systems offered by system vendors and results in capital and maintenance cost savings.

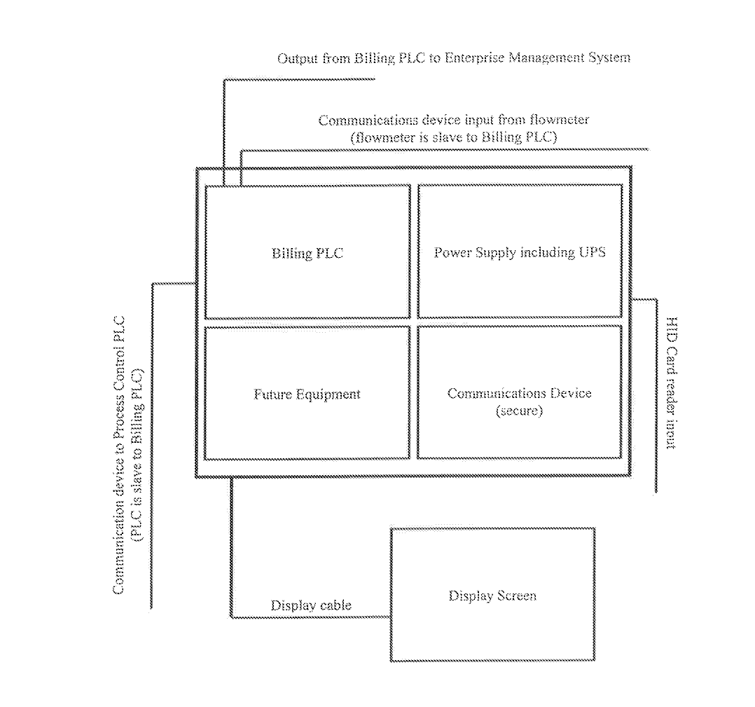

### FIELD OF THE INVENTION

The invention relates to improvements to billing systems for use in the dispensing of fuel and gas products.

### BACKGROUND OF THE INVENTION

Current fuel billing systems use proprietary computer systems and cables. These systems can have a high initial capital investment. Further support and maintenance for these systems can be expensive as the user must rely on the system vendor for support of the proprietary equipment. This can lead to other problems as the system vendor interests may not be aligned with those of the user.

The current billing systems can also represent a security risk as the billing data is controlled by the system vendor, not the user. The user does not have access to raw data and therefore can not assure security against unscrupulous parties or corrupt data.

There is a need in the art for improvements to billing systems for the dispensing and sale of fuel and gas products.

### SUMMARY OF THE PRESENT INVENTION

The invention provides and improved billing system for the dispensing of fuel and gas products. The system of the invention is comprised of non-proprietary (off the shelf) components that can be controlled by the fuel and gas seller. This avoids the need to use proprietary systems offered by system vendors thus saving capital and maintenance costs as well as giving the fuel and gas seller more direct control of the billing system.

### BRIEF DESCRIPTION OF THE DRAWING

The drawing FIGURE is a schematic diagram of the billing system according to the invention.

### DETAILED DESCRIPTION OF THE INVENTION

The invention will be described in greater detail with reference to the drawing figure. The drawing figure shows the components of the billing system of the invention. In particular, the system includes a Billing PLC unit, a Power Supply unit including a UPS and a secure communications device all interconnected and provided in a secure box. Space is also available in the box for future equipment. The box may be constructed of any material that secures the devices against tampering and damage, such as 24 bolt stainless steel. The components in the box are connected by a cable to a display screen for displaying information relative to the sale of fuel or gas products.

A communications device provides information to the Billing PLC from a flowmeter associated with the dispensing of the fuel or gas product. The flowmeter is slave to the Billing PLC. A further communications device communicates with the Process Control PLC which is also slave to the Billing PLC. An HID card reader input is also associated with the box to provide input thereto.

The Billing PLC controls the measurement process including starting and stopping the flow of fuel or gas and the zeroing of the flow meter prior to starting. The Billing PLC also instructs the Process Control PLC when to start and stop pre-conditioning activities as well as providing billing data to an Enterprise Management System.

The Power Supply unit includes a UPS (Uninterruptible Power Supply) which is normally a battery to ensure power is maintained to the Eli Fling PLC in the event of loss of mains power.

The secure communications device can take the form of simple wiring or propriety cabling systems such as Modbus or Profibus.

The invention provides many advantages. The system of the invention does not rely on proprietary computer systems and cables. Rather, the system of the invention uses non-proprietary components that can be chosen by the fuel and gas seller. This will significantly reduce the cost of the systems as the proprietary system vendors can be avoided. Further, the fuel and gas seller will not need to rely on the system vendor for maintenance, again saving costs. This also provides greater control of the system to the fuel and gas seller thus giving them greater control over the security of the system as well as greater access to the billing data.

While the system of the invention has been described with respect to fuel and gas dispensing, it is equally applicable to the sale of any product where secure sales are desired. For example the sale of hard goods could also be done using a similar system to the described for the invention.

It is anticipated that other embodiments and variations of the present invention will become readily apparent to skilled artisan in the light of the foregoing description, and it is intended that such embodiments and variations likewise be included within the scope of the invention as set out in the appended claims.

What is claimed:

1. A billing system for use in the dispensing of fuel and gas products comprising:
a billing PLC unit;
a power supply unit having a UPS; and
a secure communications device;
wherein the billing PLC unit, the power supply and the secure communications device are interconnected and provided in a secure box.

2. The billing system according to claim 1 further comprising an interconnected display screen.

3. The billing, system according to claim 1 wherein the secure box is made of 24 bolt stainless steel.

4. The billing system according to claim 1 further comprising an interconnected HID card reader.

5. The billing system according to claim 1 wherein in the power supply unit is a battery.

6. The billing system according to claim 1 wherein the secure communications device is a Modbus or Profibus.
